(19) United States
(12) Patent Application Publication
(10) Pub. No.: US 2019/0384108 A1
(43) Pub. Date: Dec. 19, 2019

(54) LIQUID CRYSTAL DISPLAY

(71) Applicant: HUIZHOU CHINA STAR OPTOELECTRONICS TECHNOLOGY CO., LTD., Huizhou Guangdong (CN)

(72) Inventors: Bo HAI, Huizhou, Guangdong (CN); Dongze LI, Huizhou Guangdong (CN); Yung-jui LEE, Huizhou, Guangdong (CN); Yuchun HSIAO, Huizhou, Guangdong (CN)

(21) Appl. No.: 15/754,269

(22) PCT Filed: Dec. 14, 2017
(86) PCT No.: PCT/CN2017/116040

§ 371 Date: Feb. 21, 2018

(30) Foreign Application Priority Data
Nov. 1, 2017 (CN) 201711059831.6

(51) Int. Cl. G02F 1/1335

(52) U.S. Cl. CPC G02F 1/133528; G02F 1/133621; G02F 1/133603

(57) ABSTRACT

A liquid crystal display is provided, which comprises a backlight module and a display module. The backlight module includes a backlight source. The display module includes a lower polarizer, a liquid crystal layer, and an upper polarizer. The liquid crystal layer is located between the upper polarizer and the lower polarizer. The backlight source includes a light shield and a LED chip located in the light shield. The inner surface of the light shield is coated with a phosphor layer. The lower polarizer includes a quantum dot (QD) layer and a polarization layer located between the QD layer and the liquid crystal layer. Light emitted by the LED chip passes through the phosphor layer and the QD layer in a serial to form white light projected outward. By placing the QD layer at the bottom of the polarization layer, the quality of the whole liquid crystal display can be enhanced.

### RELATED APPLICATIONS

The present application is a National Phase of International Application Number PCT/CN2017/116040, filed Dec. 14, 2017, and claims the priority of China Application 201711059831.6, filed Nov. 1, 2017.

### FIELD OF THE DISCLOSURE

The present invention is related to liquid crystal display technology, and more particularly is related to a liquid crystal display (LCD).

### BACKGROUND

In the last few decades, LCD is always a synonym of display technology. But in recent years, the advance display technologies such as organic light emitting diode (OLED), laser display, micro light emitting diode (LED) and etc. have emerged in the market showing the tendency to replace the LCD display technology. In this instance, LCD technology also evolved to strengthen the weakness by using new technologies and new designs, and quantum dots (QDs) is one of the most beneficial attempts.

Because QDs material has the advantages such as high color purity and continuously tunable spectrum, it has become the best luminescent material in the twenty-first century, which is capable to improve color appearance of the existing LCDs significantly, and thus has been widely adopted in the field of display technology in recent years. Other than the enhancement of color gamut, QDs material is also capable to enhance viewing angle of the display with the feature of isotropic stimulated emission. Viewing angle is indeed always an important evaluation factor for LCDs. However, under the limitations of liquid crystal modes and backlight design, the image quality of the LCDs, such as twisted nematic (TN), vertical aligned (VA); and etc., at the position with a large viewing angle is much worse than the image quality when viewed in front of the screen.

### SUMMARY

In view of the insufficiencies of the conventional technology, a liquid crystal display with the features of high color gamut and a wide viewing angle is provided in the present invention to enhance the quality of the liquid crystal display as a whole.

A liquid crystal display is provided in the present invention. The liquid crystal display comprises a backlight module and a display module, wherein the backlight module includes a backlight source, the display module includes a lower polarizer, a liquid crystal layer, and an upper polarizer, the liquid crystal layer is located between the upper polarizer and the lower polarizer, the backlight source includes a light shield and a light emitting diode (LED) chip located in the light shield, an inner surface of the light shield is coated with a phosphor layer, the lower polarizer includes a quantum dot (QD) layer and a polarization layer, and the polarization layer is located between the QD layer and the liquid crystal layer, wherein light emitted by the LED chip passes through the phosphor layer and the QD layer in a serial to form white light projected outward.

In an embodiment, the LED chip is a blue LED chip, the phosphor layer is a red phosphor layer, and the QD layer is a green QD layer.

In an embodiment, the phosphor layer is made of a fluoride or a nitride.

In an embodiment, the fluoride is represented by the following general formula: AₓMF_{y}: Mn⁴⁺ wherein A is selected from Li, Na, K, Ca, Sr, and Ba, and M is selected from Si, Al, Y, and Sc.

In an embodiment, the green QD layer is a film formed by mixing green quantum dots, a dispersion solvent, and a polymer matrix.

In an embodiment, the green QD layer is doped with red quantum dots.

In an embodiment, the liquid crystal display further comprises a red QD layer located at a bottom of the green QD layer or between the green QD layer and the polarization layer.

In an embodiment, the red QD layer is a film formed by mixing red quantum dots, a dispersion solvent, and a polymer matrix.

In an embodiment, the green quantum dots and the red quantum dots are both oil-soluble materials, the dispersion solvent is a non-polar solvent, and the polymer matrix is selected from acrylic resin, epoxy resin, cycloolefin polymer, organic silane-based resin, and cellulose ester.

In an embodiment, the polarization layer includes a polarization film, a compensation film, an adhering layer, and a substrate from a bottom to a top thereof.

The liquid crystal display provided in the present invention places the QD layer at the bottom of the polarization layer to form the QD structure with high color gamut and wide viewing angle so as to enhance the quality of the whole liquid crystal display. In addition, by placing the QD layer at the bottom layer of the lower polarizer, it is capable to prevent the prism sheet of the backlight module to receive the light emitted by the QD layer such that the brightness of the liquid crystal display can be effectively enhanced together with the enhance of color gamut. In addition, by forming the QD layer as a film in the lower polarizer, the thickness of the liquid crystal display can be reduced.

### BRIEF DESCRIPTION OF THE DRAWINGS

FIG. 1 is a structural schematic view of a liquid crystal display in accordance with a first embodiment of the present invention.

FIG. 2 is a structural schematic view of a lower polarizer n accordance with the first embodiment of the present invention.

FIG. 3 is a diagram showing the emission spectrums of fluoride and nitride.

FIG. 4 is a structural schematic view of a liquid crystal display in accordance with a second embodiment of the present invention.

FIG. 5 is a structural schematic view of a lower polarizer in accordance with a third embodiment of the present invention.

FIG. 6 is a structural schematic view of a lower polarizer in accordance with a fourth embodiment of the present invention.

### DETAILED DESCRIPTION OF PREFERRED EMBODIMENTS

In the following description, the present invention will be further illustrated in detail in combination with accompanying drawings and embodiments hereinafter. However, the disclosure can be embodied in many forms of substitution, and should not be interpreted as merely limited to the embodiments described herein. In the contrary, the embodiments are for illustrating the principle of the invention and the practical application thereof in order to have a person skilled in the art to understand the embodiments described herein and the various substitutions. In the drawings, the same labels are used for representing the same elements.

### First Embodiment

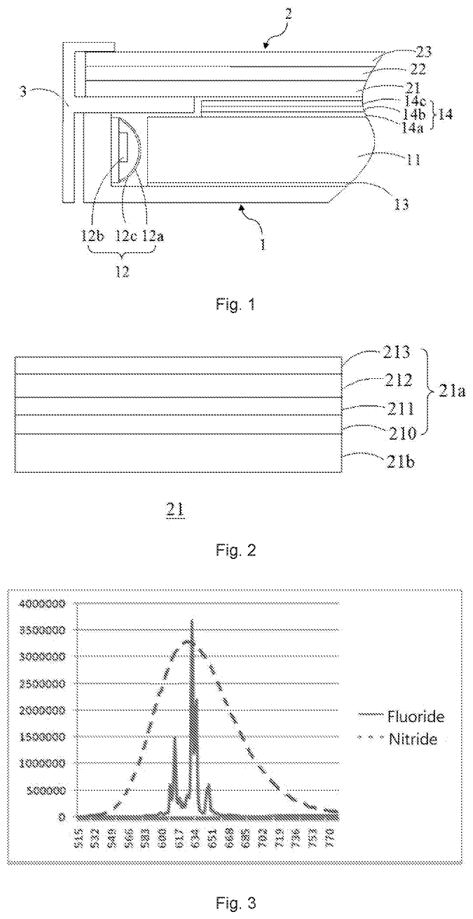

Please refer to FIG. 1 and FIG. 2, the liquid crystal display disclosed in the present embodiment is an edge-lit liquid crystal display and includes a backlight module 1 and display module 2. The backlight module 1 includes a light guide 11 and a backlight source 12. The backlight source 12 is disposed opposite to the light incident surface of the light guide 11. The display module 2 includes a lower polarizer 21, a liquid crystal layer 22, and an upper polarizer 23. The lower polarizer 21 is located between the light guide 11 and the liquid crystal layer 22. The liquid crystal layer 22 is located between the lower polarizer 21 and the upper polarizer 23. The backlight source 12 includes a light cover 12a and a light emitting diode (LED) chip 12b located in the light cover 12a. The inner surface of the light cover 12a is coated with a phosphor layer 12c. The lower polarizer 21 includes a polarization layer 21a and a quantum dot (QD) layer 21b located between the polarization layer 21a and the light guide 11. The light emitted by the LED chip 12b passes through the phosphor layer 12c and the QD layer 21b in a serial to form white light projected outward.

The backlight module 1 in the present embodiment is an edge-lit backlight module. The backlight source 12 is disposed on a side surface of the light guide 11. The light incident surface of the light guide 11 indicates the surface of the light guide 11 facing the backlight source 12. The light emitted by the LED chip 12b is projected to the phosphor layer 12c to excite the phosphor layer 12c to illuminate. The light emitted by the phosphor layer 12c as well as the light emitting by the LED chip 12b are projected to the light guide 11 and emitted from the illuminating surface of the light guide 11 after several times of reflections. In this embodiment, the illuminating surface of the light guide 11 indicates the surface of the light guide 11 facing the QD layer 21b. The light emitted from the illuminating surface of the light guide 11 is projected to the QD layer 21b to excite the QD layer 21b to generate fluorescent light. The light emitted by the LED chip 12b, the light emitted by the phosphor layer 12c, and the fluorescent light emitted by the QD layer 21b are mixed to form white light emitted outward from the QD layer 21b.

Because the size of QDs material in all directions is within the range of quantum confinement and the generated fluorescent radiation does have directivity, the excited fluorescent light would be radiated in 360 degrees with no difference, such that the brightness at different viewing angles can be effectively balanced. Therefore, by placing a QD layer 21b between the polarization layer 21a and the light guide 11, the QD structure with high color gamut and wide viewing angle can be formed so as to enhance the quality of the whole liquid crystal display. In addition, by placing the QD layer 21b at the bottom layer of the lower polarizer 21, it is capable to prevent the prism sheet of the backlight module 1 to receive the light emitted by the QD layer 21b such that the brightness of the liquid crystal display can be effectively enhanced together with the enhance of color gamut. In addition, by forming the QD layer 21b as a film in the lower polarizer 21, the thickness of the liquid crystal display can be reduced.

The LED chip 12b in the present embodiment is a blue LED chip, the phosphor layer 12c is a red phosphor layer, the QD layer 21b is a green QD layer. The red phosphor layer would be excited by the blue LED chip to generate red light. The green QD layer would be excited by the blue LED chip to cause electron transition to generate green fluorescent light. Thereby, the blue light emitted by the blue LED chip, the red light emitted by the red phosphor layer, and the green light emitted by the green QD layer are mixed to generate white light so as to make sure that the light entering the polarization layer 21a is white light. Of course, the present embodiment may use the phosphor layer 12c and the QD layer 21b with different illuminating colors if the only limitation that the light leaving the QD layer 21b is white light can be satisfied. In order to achieve a better lighting effect, it is preferred to choose the red phosphor layer as the phosphor layer 12c and the green QD layer as the QD layer 21b.

The phosphor layer 12c is made of a fluoride or a nitride. The emission spectrums of the fluoride and the nitride are shown in FIG. 3. The fluoride is represented by the formula: AₓMF_{y}: Mn⁴⁺, wherein A is selected from Li, Na, K, Ca, Sr, and Ba, and M is selected from Si, Al, Y, and Sc. Generally, the common fluoride has three categories, i.e. KSF, KGF, and KTF, wherein KSF is of cubic structure, KGF and KTF are of hexagonal structure. The three categories are known as Mn⁴⁺-activated Potassium/Germanium/Titanium silicofluoride, which are represented by the formulas: K₂SiF₆: Mn⁴⁺, K₂GeF₆: Mn⁴⁺, and K₂TiF₆: Mn⁴⁺, respectively. In Table 1, peak wavelength and half wave width of the fluoride and the nitride are shown.

TABLE 1

| | | | Preferred | |
|---|---|---|---|---|
| | | Peak | Peak | Half wave |
| | | wavelength | wavelength | width |
| | color | (nm) | (nm) | (nm) |
| nitride | red | 615-660 | 615-660 | 75-95 |
| fluoride | red | 620-640 | 630 | <30 |

The green QD layer in the present embodiment is formed as a film by mixing green quantum dots, a dispersion solvent, and a polymer matrix. The green quantum dots are provided as an oil-soluble material, which includes a core and an inorganic shell. The material of the core is selected from ZnCdSe₂, InP, Cd₂SSe, ZnCuInSₓSe_{y} and CuInSₓ. The material of the inorganic shell is selected from the group composed of CdS, ZnSe, ZnCdS₂, ZnS, ZnO, and a combination thereof.

The dispersion solvent is a non-polar solvent. The non-polar solvent is selected from the group composed of Pentane, n-Hexane, n-Heptane, Cyclopentane, Cyclohexane, Dichloromethane, Trichloromethane, Toluene, Petroleum ether, and a composition thereof, and preferably, the non-polar solvent is selected from the group composed of n-Hexane, Cyclopentane, Toluene, and a composition thereof. The polymer matrix is selected from acrylic resin, epoxy resin, cycloolefin polymer, organic silane-based resin, and cellulose ester, and preferably, the polymer matrix is made of the material with high barrier property such as cycloolefin polymer and organic silane-based resin.

The process for forming the green QD layer as a film includes the solvent processing and the physical processing processes, such as thermosetting technology, light curing technology, and hot-melt extrusion technology, so as to adhere the green QD layer on the polarization layer 21a to form the lower polarizer 21.

The green QD layer in the present embodiment only includes the green quantum dots so as to prevent the issue of improper mixing QD materials of multiple colors to lower down the illuminating efficiency, such that the difficulty and the time for forming the film can be reduced.

The polarization layer 21a in the present embodiment includes a polarization film 210, a compensation film 211, an adhering layer 212, and a substrate 213 stacked on the QD layer 21b from the bottom to the top in a serial. The polarization film 210 is made of Polyvinyl alcohol (PVA) and has the function to polarize the light passing through. The compensation film 211 acts as the protection layer for the polarization film 210, and has the functions of isolating moisture and compensating viewing angle. The adhering layer 212 is made of pressure-sensitive adhesive (PSA), which is utilized for adhering the compensation film 211 and the substrate 213 together. The substrate 213 in the present embodiment is made of glass.

The backlight module 1 in the present embodiment also includes a reflective layer 13 located at the bottom of the light guide 11 and the optical film set 14 on the top of the light guide 11. The reflective layer 13 can be a reflective plate or a reflective coating layer coated on the bottom of the light guide 11. The optical film set 14 includes a lower diffuser 14a, an enhancement film 14b, and an upper diffuser 14c from the bottom to the top in a serial. The upper diffuser 14c is located between the enhancement film 14b and the display module 2. The lower diffuser 14a is located between the enhancement film 14b and the light guide 11. The lower diffuser 14a is utilized for collecting the light emitted from the illuminating surface of the light guide 11 and uniformly projecting the light to the enhancement film 14b. The enhancement film 14b is utilized for concentrating the dispersed light emitted from the lower diffuser 14a to enhance brightness. The upper diffuser 14c is utilized for spreading the light emitted from the enhancement film 14b and projecting the light outward uniformly. In the present embodiment, the enhancement film 14b is a prism sheet.

The liquid crystal display in the present embodiment also includes a frame 3 for supporting the backlight module 1 and the display module 2.

### Second Embodiment

The major difference between the present embodiment and the first embodiment is that, the liquid crystal display in the present embodiment is a direct-lit liquid crystal display.

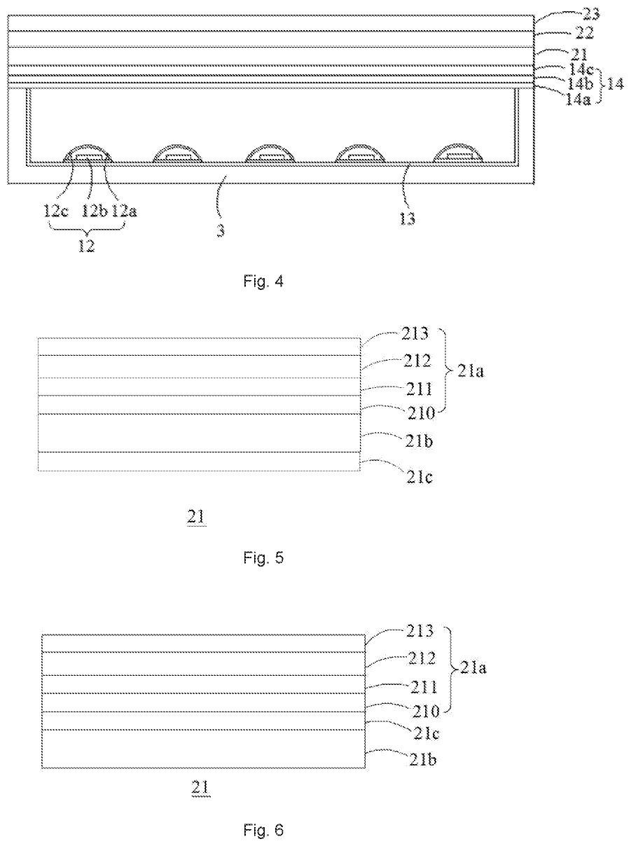

As shown in FIG. 4, the liquid crystal display in the present embodiment includes a backlight module 1 and a display module 2. The backlight module 1 includes a backlight source 12. The backlight source 12 is located at a bottom of the display module 2. The display module 2 includes a lower polarizer 21, a liquid crystal layer 22, and an upper polarizer 23. The liquid crystal layer 22 is located between the lower polarizer 21 and the upper polarizer 23. The backlight source 12 includes a light cover 12a and a LED chip 12b located in the light cover 12a. The inner surface of the light cover 12a is coated with a phosphor layer 12c. The lower polarizer 21 includes a polarization layer 21a and a QD layer 21b located between the polarization layer 21a and the light guide 11. The light emitted by the LED chip 12b passes through the phosphor layer 12c and the QD layer 21b in a serial to form white light projected outward.

The light emitted by the LED chip 12b is projected to the phosphor layer 12c to excite the phosphor layer 12c to emit light, the light emitted by the phosphor layer 12c and the light emitted by the LED chip 12b are projected to the QD layer 21b, and the QD layer 21b is excited to emit fluorescent light. The light emitted by the LED chip 12b, the light emitted by the phosphor layer 12c, and the fluorescent light emitted by the QD layer 21b are mixed to form white light projected outward from the QD layer 21b.

Because the size of QDs material in all directions is within the range of quantum confinement and the generated fluorescent radiation does not have directivity, the excited fluorescent light would be radiated in 360 degrees with no difference, such that the brightness at different viewing angles can be effectively balanced. Therefore, by placing the QD layer 21b at the bottom of the display module 2, the QD structure with high color gamut and wide viewing angle can be formed so as to enhance the quality of the whole liquid crystal display. In addition, by placing the QD layer 21b at the bottom layer of the lower polarizer 21, it is capable to prevent the prism sheet of the backlight module 1 to receive the light emitted by the QD layer 21b such that the brightness of the liquid crystal display can be effectively enhanced together with the enhance of color gamut. In addition, by forming the QD layer 21b as a film in the lower polarizer 21, the thickness of the liquid crystal display can be reduced.

The LED chip 12b, the phosphor layer 12c, the QD layer 21b, and the polarization layer 21a are identical to that described in the first embodiment and thus are not repeated here.

The backlight module 1 in the present embodiment also includes a reflective layer 13 located at the bottom of the backlight source 12 and an optical film set 14 on the top of the backlight source 12. The reflective layer 13 can be a reflective plate or a reflective coating layer. The optical film set 14 includes a lower diffuser 14a, an enhancement film 14b, and an upper diffuser 14c from the bottom to the top in a serial. The upper diffuser 14c is located between the enhancement film 14b and the display module 2. The lower diffuser 14a is located between the enhancement film 14b and the backlight source 12. The lower diffuser 14a is utilized for collecting the light emitted from the backlight source 12 and uniformly projecting the light to the enhancement film 14b. The enhancement film 14b is utilized for concentrating the dispersed light emitted from the lower diffuser 14a to enhance brightness. The upper diffuser 14c is utilized for spreading the light emitted from the enhancement film 14b and projecting the light outward uniformly. In the present embodiment, the enhancement film 14b is a prism sheet.

The liquid crystal display in the present embodiment further includes a frame 3 for supporting the backlight module 1 and the display module. The reflective layer 13 covers the inner surface of the frame 3 such that most of the light emitted by the backlight source 12 would be reflected to the optical film set 14 by the reflective layer 13 so as to enhance the illuminating efficiency of the backlight source 12.

### Third Embodiment

The difference between the present embodiment and the first embodiment is that, the green QD layer in the present embodiment is doped with some red quantum dots. Because red light has lesser energy, it would be helpful to dope a small amount of low concentration red quantum dots into the green QD layer to enhance color saturation of red color such that the color gamut of the whole liquid crystal display can be enhanced

The red quantum dots are provided as an oil-soluble material, which includes a core and an inorganic shell. The material of the core is selected from CdSe, Cd₂SeTe, InAs, ZnCuInSₓSe_{y}, and CuInSₓ. The material of the inorganic shell is selected from the group composed of CdS, ZnSe, ZnCdS₂, ZnS, ZnO, and a combination thereof.

### Fourth Embodiment

Please refer to FIG. 5, the difference between the present embodiment and the first embodiment is that, the lower polarizer 21 in the present embodiment further includes a red QD layer 21c located between the green QD layer and the upper diffuser 14c. The present embodiment is capable to enhance color saturation of red color and color gamut of the whole liquid crystal display, and is also capable to prevent the event issue of improper mixing QD materials of multiple colors to lower down the illuminating efficiency, such that the difficulty and the time for forming the film can be reduced.

The red QD layer 21c is formed as a film by mixing red quantum dots, a dispersion solvent, and a polymer matrix. The red quantum dots are provided as an oil-soluble material, which includes a core and an inorganic shell. The material of the core is selected from CdSe, Cd₂SeTe, InAs, ZnCuInSₓSe_{y}, and CuInSₓ. The material of the inorganic shell is selected from the group composed of CdS, ZnSe, ZnCdS₂, ZnS, ZnO, and a combination thereof.

The dispersion solvent is a non-polar solvent. The non-polar solvent is selected from the group composed of Pentane, n-Hexane, n-Heptane, Cyclopentane, Cyclohexane, Dichloromethane, Trichloromethane, Toluene, Petroleum ether, and a composition thereof, and preferably, the non-polar solvent is selected from the group composed of n-Hexane, Cyclopentane, Toluene, and a composition thereof. The polymer matrix is selected from acrylic resin, epoxy resin, cycloolefin polymer, organic silane-based resin, and cellulose ester, and preferably, the polymer matrix is made of the material with high barrier property such as cycloolefin polymer and organic silane-based resin.

### Fifth Embodiment

Please refer to FIG. 6, the difference between the present embodiment and the fourth embodiment is that the red QD layer 21c in the present embodiment is located between the green QD layer and the polarization layer 21a. The present embodiment may further enhance color saturation of red color on the basis of the third embodiment so as to enhance color gamut of the whole liquid crystal display.

What is claimed is:

1. A liquid crystal display, comprising a backlight module and a display module, wherein the backlight module includes a backlight source, the display module includes a lower polarizer, a liquid crystal layer, and an upper polarizer, the liquid crystal layer is located between the upper polarizer and the lower polarizer, the backlight source includes a light shield and a light emitting diode (LED) chip located in the light shield, an inner surface of the light shield is coated with a phosphor layer, the lower polarizer includes a quantum dot (QD) layer and a polarization layer, and the polarization layer is located between the QD layer and the liquid crystal layer, wherein light emitted by the LED chip passes through the phosphor layer and the QD layer in a serial to form white light projected outward.

2. The liquid crystal display of claim 1, wherein the LED chip is a blue LED chip, the phosphor layer is a red phosphor layer, and the QD layer is a green QD layer.

3. The liquid crystal display of claim 2, wherein the phosphor layer is made of a fluoride or a nitride.

4. The liquid crystal display of claim 3, wherein the fluoride is represented by the following general formula: AₓMF_{y}: Mn⁴⁺ wherein A is selected from Li, Na, K, Ca, Sr, and Ba, and M is selected from Si, Al, Y, and Sc.

5. The liquid crystal display of claim 2, wherein the green QD layer is a film formed by mixing green quantum dots, a dispersion solvent, and a polymer matrix.

6. The liquid crystal display of claim 5, wherein the green QD layer is doped with red quantum dots.

7. The liquid crystal display of claim 5, further comprising a red QD layer located at a bottom of the green QD layer or between the green QD layer and the polarization layer.

8. The liquid crystal display of claim 7, wherein the red QD layer is a film formed by mixing red quantum dots, a dispersion solvent, and a polymer matrix.

9. The liquid crystal display of claim 5, wherein the green quantum dots and the red quantum dots are both oil-soluble materials, the dispersion solvent is a non-polar solvent, and the polymer matrix is selected from acrylic resin, epoxy resin, cycloolefin polymer, organic silane-based resin, and cellulose ester.

10. The liquid crystal display of claim 6, wherein the green quantum dots and the red quantum dots are both oil-soluble materials, the dispersion solvent is a non-polar solvent, and the polymer matrix is selected from acrylic resin, epoxy resin, cycloolefin polymer, organic silane-based resin, and cellulose ester.

11. The liquid crystal display of claim 7, wherein the green quantum dots and the red quantum dots are both oil-soluble materials, the dispersion solvent is a non-polar solvent, and the polymer matrix is selected from acrylic resin, epoxy resin, cycloolefin polymer, organic silane-based resin, and cellulose ester.

12. The liquid crystal display of claim 8, wherein the green quantum dots and the red quantum dots are both oil-soluble materials, the dispersion solvent is a non-polar solvent, and the polymer matrix is selected from acrylic resin, epoxy resin, cycloolefin polymer, organic silane-based resin, and cellulose ester.

13. The liquid crystal display of claim 1, wherein the polarization layer includes a polarization film, a compensation film, an adhering layer, and a substrate from a bottom to a top thereof.
